(19) United States
(12) Patent Application Publication
(10) Pub. No.: US 2017/0176901 A1
(43) Pub. Date: Jun. 22, 2017

(54) FIXING DEVICE AND IMAGE FORMING APPARATUS

(71) Applicant: FUJI XEROX CO., LTD., Tokyo (JP)

(72) Inventor: Akira SHIMODAIRA, Kanagawa (JP)

(73) Assignee: FUJI XEROX CO., LTD., Tokyo (JP)

(21) Appl. No.: 15/139,038

(22) Filed: Apr. 26, 2016

(30) Foreign Application Priority Data
Dec. 22, 2015 (JP) 2015-249596

(51) Int. Cl. G03G 15/20

(52) U.S. Cl. CPC G03G 15/2028

(57) ABSTRACT

A fixing device includes a heater, a heating roller, a pressure rotary member, and guide member. The heating roller has an outer circumferential surface, has a center and one and another ends in a rotational axis direction thereof, and is rotated while being heated. The pressure rotary member is in pressure contact with part of the outer circumferential surface of the heating roller extending in an axial direction of the heating roller so as to be rotated while forming a pressure contact portion which allows a recording medium bearing an unfixed image to be introduced thereinto and pass therethrough. The guide member guides a leading end of the recording medium toward part of the outer circumferential surface of the heating roller approaching the pressure contact portion. An outer diameter of the heating roller gradually reduces from the center toward the one and the other ends.

### CROSS-REFERENCE TO RELATED APPLICATIONS

This application is based on and claims priority under 35 USC 119 from Japanese Patent Application No. 2015-249596 filed Dec. 22, 2015.

### BACKGROUND

### Technical Field

The present invention relates to a fixing device and an image forming apparatus.

### SUMMARY

According to an aspect of the present invention, a fixing device includes a heater, a heating roller, a pressure rotary member, and a guide member. The heating roller has an outer circumferential surface, has a center and one and another ends in a rotational axis direction thereof, and is rotated while being heated by the heater. The pressure rotary member is in pressure contact with part of the outer circumferential surface of the heating roller extending in an axial direction of the heating roller so as to be rotated while forming a pressure contact portion which allows a recording medium having a leading end and bearing an unfixed image having been transferred to the recording medium to be introduced thereinto and pass therethrough. The guide member guides the leading end of the recording medium toward part of the outer circumferential surface of the heating roller approaching the pressure contact portion. The heating roller has a shape in which an outer diameter thereof gradually reduces from the center toward the one and the other ends.

### BRIEF DESCRIPTION OF THE DRAWINGS

Exemplary embodiment of the present invention will be described in detail based on the following figures, wherein:

FIG. 1 is a conceptual view of the structure of an image forming apparatus according to an exemplary embodiment;

FIG. 2 is an enlarged partially sectional view of parts (fixing device and second transfer portion) of the image forming apparatus of FIG. 1;

FIG. 3 is a schematic sectional view of the fixing device of FIG. 2 taken along line III-III;

FIG. 4 is a sectional view illustrating the structure of a heating roller of the fixing device of FIG. 3;

FIGS. 5A and 5B illustrate part of an operation performed by the fixing device of FIG. 2, and out of FIGS. 5A and 5B, FIG. 5A illustrates a state in which a leading end of a recording sheet fed from the second transfer portion is introduced into a pressure contact portion of the fixing device, and FIG. 5B illustrates a state in which part of the recording sheet on the leading end side is introduced into and passes through the pressure contact portion of the fixing device;

FIG. 6A illustrates a state in which the recording sheet is introduced into and passes through an introduction guide member, and FIG. 6B illustrates a state in which the recording sheet is introduced into and passes through the pressure contact portion of the fixing device;

FIGS. 7A and 7B illustrate part of the operation performed by the fixing device of FIG. 2, and out of FIGS. 7A and 7B, FIG. 7A illustrates a state of part of the recording sheet on a trailing end side when part of the recording sheet on the leading end side is introduced into and passes through the pressure contact portion of the fixing device, and FIG. 7B illustrates a state of the recording sheet when the trailing end of the recording sheet is fed from the second transfer portion;

FIG. 8 is a partially sectional view illustrating another structural example of the fixing device;

FIG. 9 is a schematic sectional view of the fixing device of FIG. 8 taken along line IX-IX;

FIGS. 10A and 10B illustrate part of the operation performed by a fixing device to be compared which may cause image disturbances, and out of FIGS. 10A and 10B, FIG. 10A illustrates a state of part of the recording sheet between the pressure contact portion and the introduction guide member when part of the recording sheet on the leading end side is introduced into and passes through the pressure contact portion of the fixing device, and FIG. 10B illustrates a state of part of the recording sheet on the trailing end side of the pressure contact portion; and

FIG. 11 illustrates a state of the recording sheet when the image disturbances occur in the fixing device of FIGS. 10A and 10B.

### DETAILED DESCRIPTION

An exemplary embodiment of the present invention (simply referred to as “exemplary embodiment” hereafter) will be described below with reference to the accompanying drawings.

### Exemplary Embodiment

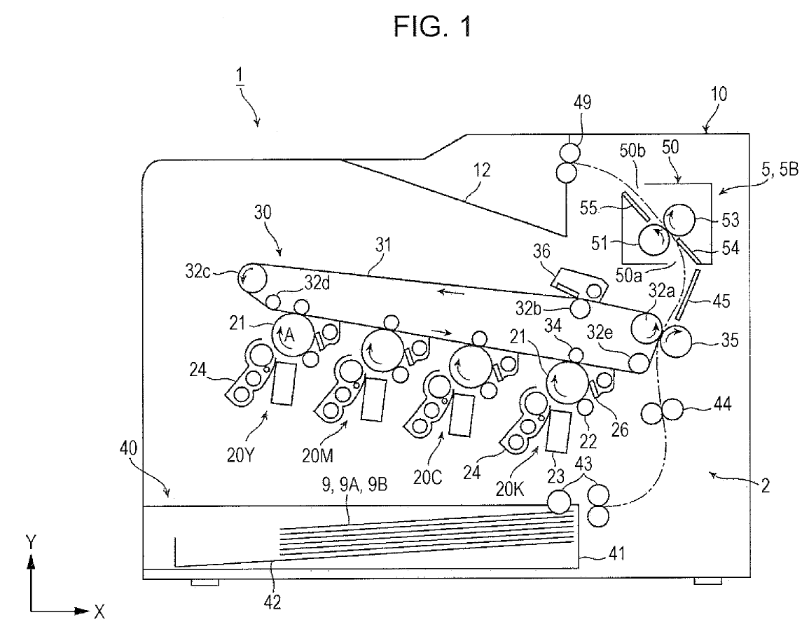

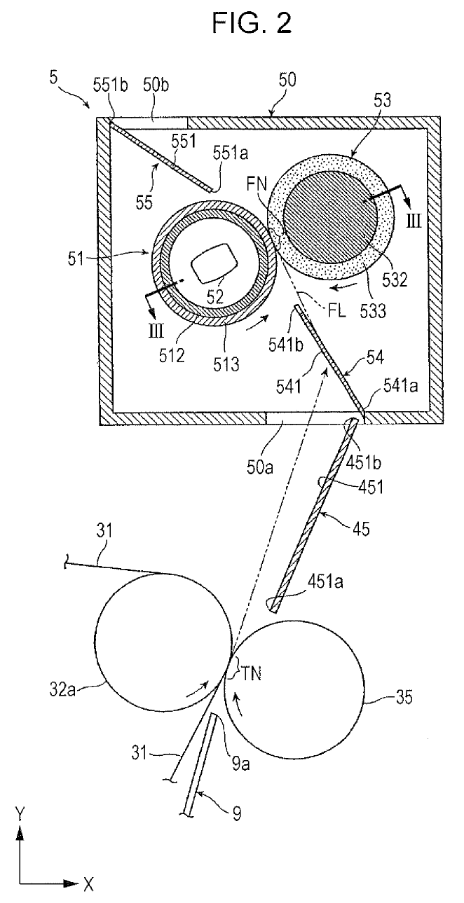

FIGS. 1 and 2 illustrate an image forming apparatus that uses a fixing device according to an exemplary embodiment. FIG. 1 conceptually illustrates an overall structure of the image forming apparatus. FIG. 2 conceptually illustrates parts (fixing device and second transfer portion) of the image forming apparatus. Arrows of the drawings such as FIG. 1 denoted by X, Y, and Z represent (the directions of) the axes of rectangular coordinates indicating the width, height, and depth directions of a three-dimensional space assumed for each of the drawings. An Overall Structure of the Image Forming Apparatus

An image forming apparatus 1 forms images formed of developer onto recording sheets of paper 9. Each of the recording sheets 9 serves as an example of a recording medium. The image forming apparatus 1 is, for example, configured as a printer that forms images in accordance with image information received from an external device such as information terminal device.

The image forming apparatus 1 includes a housing 10 having a generally box-shaped appearance. As illustrated in FIG. 1, an image forming section 2, a fixing device 5, and so forth are disposed in an inner space of the housing 10. The image forming section 2 forms toner images (unfixed images) made of toners as the developers and transfers the toner images onto the recording sheets 9. The fixing device 5 fixes the transferred toner images onto the recording sheets 9. The image forming section 2 according to the exemplary embodiment includes an image forming units 20, an intermediate transfer device 30, and a sheet feed device 40. The image forming units 20 form the toner images. The intermediate transfer device 30 transports the toner images formed by the image forming units 20 such that the toner images are relayed so as to be transferred onto the recording sheets 9 through second transfer. The sheet feed device 40 contains and feeds the recording sheets 9 to be supplied to the second transfer portion of the intermediate transfer device 30. An output sheet container 12 is formed in an upper surface portion of the housing 10. The output sheet container 12 contains the recording sheets 9 output to the outside of the housing 10 after images have been formed on the recording sheets 9. A dotted chain line of FIG. 1 represents a typical overall transport path of each of the recording sheets 9 in the housing 10.

The image forming units 20 include four image forming units 20Y, 20M, 20C, and 20K which respectively form developer (toner) images of four colors, that is, yellow (Y), magenta (M), cyan (C), and black (K).

Each of four image forming units 20 (Y, M, C, and K) includes, for example, the following components: a photosensitive drum 21 that is a drum-shaped photosensitive member rotated in an arrow A direction; a charger 22 that has, for example, a roller shape and charges an outer circumferential surface of the photosensitive drum 21, the outer circumferential surface serving as an image forming region, to a required voltage; a light exposure device 23 that radiates light of a corresponding one of color components separated in accordance with required image information to the charged outer circumferential surface of the photosensitive drum 21 so as to form an electrostatic latent image of the color component; a developing device 24 (Y, M, C, or K) that develops the electrostatic latent image with a toner of the corresponding color component so that the latent image is made visible as a toner image of the corresponding color (Y, M, C, or K); and a drum cleaner 26 that cleans the outer circumferential surface of the photosensitive drum 21 by removing unwanted substances such as the toner remaining on the outer circumferential surface of the photosensitive drum 21 after the toner image on the photosensitive drum 21 has been transferred onto (an intermediate transfer belt 31 of) the intermediate transfer device 30 through first transfer.

The intermediate transfer device 30 is positioned above four image forming units 20 (Y, M, C, and K) in the gravity direction.

The intermediate transfer device 30 includes, for example, the following components: the endless intermediate transfer belt 31 capable of holding the toner images having been formed on the photosensitive drums 21 of the image forming units 20 (Y, M, C, and K) and transferred thereonto by electrostatic action; plural support rollers 32a to 32e that support the intermediate transfer belt 31 such that the intermediate transfer belt 31 is rotated so as to sequentially pass through first transfer positions of the image forming units 20 (Y, M, C, and K); first transfer devices 34 that have, for example, a roller shape, are disposed on the inner circumferential side of the intermediate transfer belt 31, and transfer through the first transfer the toner images formed on the photosensitive drums 21 of the image forming units 20 (Y, M, C, and K) onto the outer circumferential surface of the intermediate transfer belt 31; a second transfer device 35 that has, for example, a roller shape and transfers through the second transfer the toner images having been transferred through the first transfer onto the intermediate transfer belt 31 onto the recording sheet 9; and a belt cleaner 36 that cleans the outer circumferential surface of the intermediate transfer belt 31 by removing unwanted substances such as the toners remaining on the outer circumferential surface of the intermediate transfer belt 31 after the second transfer.

More specifically, the support roller 32a serves as a drive roller and also serves as a second transfer backup roller, the support roller 32b serves as a cleaning backup roller for the belt cleaner 36, the support roller 32c serves as a tension applying roller that applies a required tension to the intermediate transfer belt 31, and the support rollers 32d and 32e serve as surface forming rollers used to form a first transfer surface of the intermediate transfer belt 31. Furthermore, in the intermediate transfer device 30, the second transfer portion is a portion formed by the second transfer device 35 and part of the intermediate transfer belt 31 where the intermediate transfer belt 31 is supported by the support roller 32a.

The sheet feed device 40 is positioned below four image forming units 20 (Y, M, C, and K) in the gravity direction.

The sheet feed device 40 is attached to the housing 10 such that the sheet feed device 40 is able to be drawn from the housing 10. The sheet feed device 40 includes a sheet container 41 and a feed device 43. The sheet container 41 contains the recording sheets 9 stacked on a loading plate 42. The recording sheets 9 are of a size, type, and the like that a user wishes. The feed device 43 feeds the recording sheets 9 one sheet after another from the sheet container 41. The housing 10 has a sheet feed path provided between the feed device 43 of the sheet feed device 40 and the second transfer portion of the intermediate transfer device 30. The sheet feed path is formed by plural transport roller pairs, a transport guide member, and so forth. One of the plural transport roller pairs is a registration roller pair 44 disposed at a position in the sheet feed path upstream of the second transfer portion. The registration roller pair 44 is provided so as to, for example, adjust timing at which each of the recording sheet 9 is transported and correct skewing of the recording sheet 9.

The fixing device 5 is positioned above the second transfer portion of the intermediate transfer device 30 in the gravity direction.

The fixing device 5 includes, for example, the following components disposed in a housing 50 thereof: a heating roller 51 that is rotated in a required direction and is heated by a heater 52 so that the surface temperature thereof is maintained at a required temperature; a pressure roller 53 that serves as an example of a pressure rotary member and is in pressure contact with the heating roller 51 at a required pressure substantially in a rotational axis direction of the heating roller 51 so as to be rotated and form a pressure contact portion (fixing process portion) FN which allows the recording sheet 9 onto which the toner images has been transferred to be introduced thereinto and pass therethrough; and an introduction guide member 54 that guides a leading end portion 9a of the recording sheet 9 toward part of an outer circumferential surface of the heating roller 51 approaching the pressure contact portion FN.

The housing 50 has an entrance (opening) 50a through which the recording sheet 9 to be subjected to fixing is introduced and an exit (opening) 50b through which the recording sheet 9 having undergone the fixing is output. Furthermore, a post-transfer guide member 45 is disposed between the entrance 50a side of the housing 50 of the fixing device 5 and the second transfer portion of the intermediate transfer device 30. The post-transfer guide member 45 forms a post-transfer transport path through which the recording sheet 9 having undergone the second transfer is guided toward the entrance 50a of the fixing device 5.

The details of the fixing device 5 will be described later.

Image formation is performed by this image forming apparatus 1 as follows. Here, a basic image forming operation that forms an image on a single side of the recording sheet 9 is described as a representative example of the image formation.

Upon reception of a start instruction for an image forming operation, the image forming apparatus 1 performs the following operations in the image forming units 20 (Y, M, C, and K). That is, the chargers 22 charge to a specified polarity and voltage the outer circumferential surfaces of the photosensitive drums 21 which is started to rotate, and then, the light exposure devices 23 radiate the light corresponding to image signals of the color components to the charged outer circumferential surfaces of the photosensitive drums 21 so as to form electrostatic latent images. Next, the developing devices 24 (Y, M, C, and K) develop the electrostatic latent images of the color components formed on the outer circumferential surfaces of the photosensitive drums 21 by supplying the toners of four colors (Y, M, C, and K) corresponding to the color components. Thus, the toner images of four colors are formed on the photosensitive drums 21 of the respective image forming units 20 (Y, M, C, and K).

Next, in the intermediate transfer device 30, the toner images of the colors having been formed on the photosensitive drums 21 of the respective image forming units 20 (Y, M, C, and K) are sequentially transferred through the first transfer performed by the first transfer devices 34 onto the outer circumferential surface of the intermediate transfer belt 31 being rotated in a direction indicated by an arrow. After the first transfer has been performed, the outer circumferential surfaces of the photosensitive drums 21 are cleaned by the drum cleaners 26. The sheet feed device 40 feeds the required recording sheets 9 one sheet after another from the sheet container 41 toward the sheet feed path by using the feed device 43. Next, in the intermediate transfer device 30, the toner images having been transferred through the first transfer onto the intermediate transfer belt 31 are transported to the second transfer portion and collectively transferred through the second transfer performed by the second transfer device 35 onto the recording sheet 9 having been transported from the sheet feed device 40 to the second transfer portion through the sheet feed path. After the second transfer has been performed, the outer circumferential surface of the intermediate transfer belt 31 is cleaned by the belt cleaner 36.

Next, in the intermediate transfer device 30, the recording sheet 9 onto which the toner images have been transferred through the second transfer is removed from the intermediate transfer belt 31, and then, fed to the fixing device 5. The recording sheet 9 after the second transfer is guided to the entrance 50a of the housing 50 of the fixing device 5 through, for example, guidance performed by the post-transfer guide member 45, and then, guided by the introduction guide member 54 so as to be introduced into the pressure contact portion FN. Next, in the fixing device 5, the recording sheet 9 onto which the toner images have been transferred through the second transfer is heated and pressed while passing through the pressure contact portion FN formed between the heating roller 51 and the pressure roller 53 which are being rotated. Thus, the toner images are fused and fixed onto the recording sheet 9. The fixing device 5 outputs the recording sheet 9 having undergone this fixing through the exit 50b of the housing 50.

At last, the recording sheet 9 having been output from the fixing device 5 is output to the outside of the housing 10 by an output roller pair 49 disposed at an end portion (sheet output opening) of the overall transport path indicated by the dotted chain line and finally received by the output sheet container 12.

Thus, a color image of the toners of four colors (Y, M, C, and K) is formed on a single side of a single recording sheet 9, and the basic image forming operation performed by the image forming apparatus 1 is completed. When an instruction for performing the image forming operation on plural sheets is issued, the above-described series of operations are similarly repeatedly performed as many times as the instructed number of sheets.

In the image forming apparatus 1, by selecting and operating all or some (plural) of the image forming units 20 (Y, M, C, and K), a color image of all or some (at least plural) of the toners of four colors (Y, M, C, and K) combined with one another may be formed. Furthermore, by operating one of the image forming units 20 (Y, M, C, and K), a monochrome image of one of the toners of the colors, for example, a black may be formed.

Furthermore, for the image forming apparatus 1, a so-called center registration method is adopted as a transport regulating method. The center registration method regulates transport of the recording sheet 9 as follows: that is, the recording sheet 9 is transported so that a portion of the recording sheet 9 matching to the center in a feed width of the recording sheet 9 passes through a position of the transport path matching to the center of a feed width of a recording-sheet-9 transport path (transport space) in a range from the sheet feed device 40 to an output portion of the fixing device 5 through the second transfer portion.

### A Detailed Structure of the Fixing Device

Next, the fixing device 5 is further described.

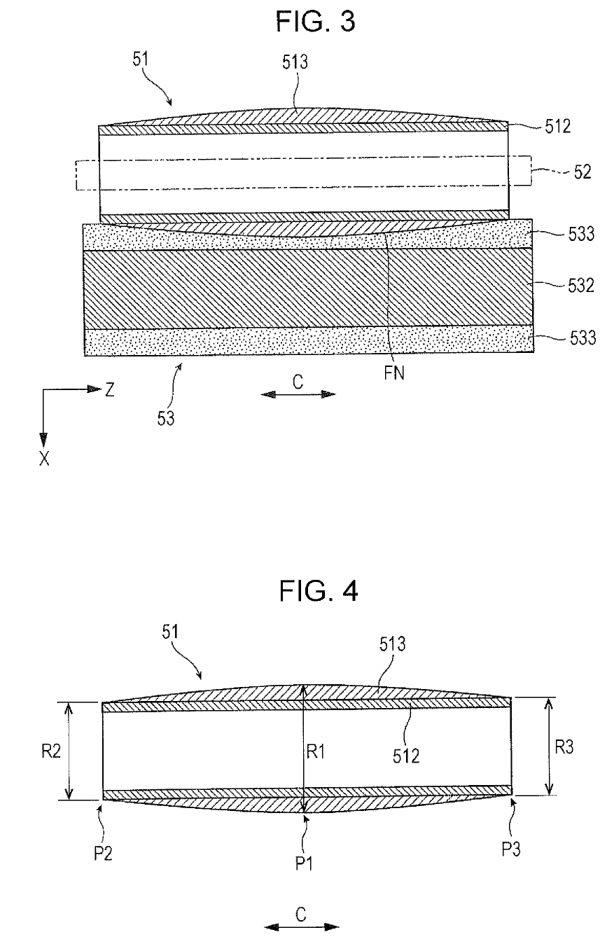

As illustrated in, for example, FIG. 3, the heating roller 51 of the fixing device 5 includes a cylindrical roller base member 512 formed of a material such as a metal material and a surface layer 513 formed of a material such as silicone. The surface layer 513 is provided on an outer circumferential surface of the roller base member 512. The heating roller 51 may further include another layer such as a mold release layer on the surface layer 513 according to need.

The heating roller 51 has, as illustrated in, for example, FIG. 4, a shape in which an outer diameter R of the heating roller 51 gradually reduces from a center P1 toward both ends P2 and P3 (so-called crowned-roller shape or spindle shape) in the rotational axis direction C (along the coordinate axis Z direction). That is, the outer diameter R of a heating roller 51B is largest at the center P1 where the outer diameter is R1 and smallest at both the ends P2 and P3 where the outer diameters are R2 and R3. The outer diameters R2 and R3 are the same. Here, both the ends P2 and P3 of the heating roller 51 in the rotational axis direction C are, for example, both ends of a region through which one of types of the recording sheets 9 having a largest width out of types of the recording sheets 9 to be subjected to the fixing passes. This region is in a range of the outer circumferential surface of the heating roller 51 in the rotational axis direction C.

This heating roller 51 having a non-uniform outer diameter R is formed by, for example, processing the surface layer 513 provided on the roller base member 512 having a uniform outer diameter in the rotational axis direction C, so that the heating roller 51B has the above-described outer diameter R. Furthermore, the difference (in percentage) by which the outer diameter R1 at the center P1 is larger than the outer diameters R2 and R3 at both the ends P2 and P3 in the heating roller 51 is preferably set in a range, for example, from 0.1 to 1.0%. In the case where the difference in the outer diameter is less than the above-described lower limit value, problems including the following problems may arise: that is, the effect of suppressing the occurrences of the image disturbances, which will be described later, is not obtained or unlikely to be obtained; and the position of the recording sheet 9 is unstable while being transported through the pressure contact portion FN. In contrast, in the case where the difference in the outer diameter is more than the above-described upper limit value, problems including the following problem may arise: that is, creasing (paper crease) in the recording sheet 9 occurs when the recording sheet 9 is passes through the pressure contact portion FN.

Furthermore, the heating roller 51 is heated by the heater 52 such as a halogen heater provided in an inner space of the roller base member 512 so that the temperature of the outer circumferential surface of the heating roller 51 becomes a required temperature. Furthermore, the temperature of the outer circumferential surface of the heating roller 51 is maintained at the required temperature by controlling operation of the heater 52 while detecting the temperature of the outer circumferential surface of the heating roller 51 by using a temperature sensor (not illustrated). Furthermore, the heating roller 51 is rotatably attached in part of the housing 50 and rotated in a direction indicated by an arrow by a rotating drive transmitted thereto from a rotation drive device (not illustrated).

As illustrated in, for example, FIG. 3, the pressure roller 53 of the fixing device 5 includes a cylindrical roller base member 532 formed of a material such as a metal material. An elastic layer 533 formed of a material such as urethane and a mold release layer (not illustrated) formed of a material such as polyimide are provided on an outer circumferential surface of the roller base member 532 in this order. The material of the elastic layer 533 according to the exemplary embodiment is an elastic material that is elastically deformed so as to follow the shape of the outer circumferential surface of the heating roller 51 when the elastic layer 533 is in pressure contact with the heating roller 51.

Furthermore, the pressure roller 53 is rotatably attached in part of the housing 50 and in pressure contact with the heating roller 51 by receiving a pressure generated by a pressure device (not illustrated).

The introduction guide member 54 of the fixing device 5 is structured as a continuous member that has a guide portion 541, which guides the leading end portion 9a of the recording sheet 9, gradually approaches the pressure contact portion FN. Furthermore, the introduction guide member 54 is disposed such that a guide ending portion 541b where the guide portion 541 ends the guidance exists on the heating roller 51 side of a tangent FL on an entrance side of the pressure contact portion FN. Furthermore, the introduction guide member 54 is secured such that a guide starting portion 541a located on a side where the guide portion 541 starts the guidance exists at an edge of the opening of the entrance 50a of the housing 50. The introduction guide member 54 according to the exemplary embodiment includes a flat plate-shaped member that includes the guide portion 541 having a flat surface.

An output guide member 55 of the fixing device 5 guides the recording sheet 9 having passed through the pressure contact portion FN so as to separate the recording sheet 9 from the heating roller 51 and direct the recording sheet 9 toward the exit 50b of the housing 50. The output guide member 55 is disposed such that a guide starting portion 551a of a guide portion 551 that guides the recording sheet 9 is disposed close to part of the outer circumferential surface of the heating roller 51 past the pressure contact portion FN and a guide ending portion 551b of the guide portion 551 exists at an edge portion of the exit 50b of the housing 50.

Furthermore, in the fixing device 5 according to the exemplary embodiment, the rotational speed of the heating roller 51 is set to be slightly lower (by, for example, 0.1 to 2%) than the rotational speed of the support roller 32a, which also serves as the drive roller, of the second transfer portion of the intermediate transfer device 30. Thus, the transport speed of the recording sheet 9 is lower when the recording sheet 9 is nipped in the pressure contact portion FN of the fixing device 5 than when the recording sheet 9 is nipped in a pressure contact portion (transfer portion) TN by a speed substantially corresponding to the speed by which the rotational speed of the heating roller 51 is reduced. The intermediate transfer belt 31 and the second transfer device 35 are in pressure contact with each other in the pressure contact portion TN of the second transfer portion.

Furthermore, the post-transfer guide member 45 has a guide portion 451 between the second transfer portion of the intermediate transfer device 30 and the introduction guide member 54 of the fixing device 5. The guide portion 451 guides the leading end 9a of the recording sheet 9 so as to cause the leading end 9a to be brought into contact with at least the guide portion 541 of the introduction guide member 54. The post-transfer guide member 45 is disposed such that a guide starting portion 451a serving as a starting side end portion of the guide portion 451 is disposed close to part of the outer circumferential surface of the second transfer device (second transfer roller) 35 past the pressure contact portion TN and a guide ending portion 451b on a side where the guide portion 451 ends the guidance is disposed close to the guide starting portion 541a of the guide portion 541 of the introduction guide member 54.

### Fixing Operation Performed by the Fixing Device

Fixing operation performed by the fixing device 5 is described below.

Initially, when the fixing device 5 is in operating for, for example, image formation, the heating roller 51 is rotated in the direction indicated by the arrow and maintained in a state in which the heating roller 51 is heated to the required temperature by the heater 52. The pressure roller 53 is rotated by following the rotating heating roller 51.

In the fixing device 5, the shape of the outer circumferential surface of the heating roller 51 is formed such that the outer diameter R of the heating roller 51 gradually reduces from the center P1 toward both the ends P2 and P3 in the rotational axis direction C, and the elastic layer 533 of the pressure roller 53 is elastically deformed so as to follow the shape of the outer circumferential surface of the heating roller 51 when the elastic layer 533 is in pressure contact with the heating roller 51. This causes the pressure contact portion FN to have a curved shape in the rotational axis direction C in which a central portion of the heating roller 51 projects toward the pressure roller 53 side as exemplified in FIG. 3 in the fixing device 5.

When the image forming operation is started, as exemplified by a two-dot chain arrow of FIG. 2, the recording sheet 9 onto which the toner images have been transferred through the second transfer by the second transfer portion of the intermediate transfer device 30 of the image forming section 2 is fed from the pressure contact portion TN of the second transfer portion, and then, transported to the entrance 50a of the housing 50 of the fixing device 5 through, for example, guidance performed by the post-transfer guide member 45.

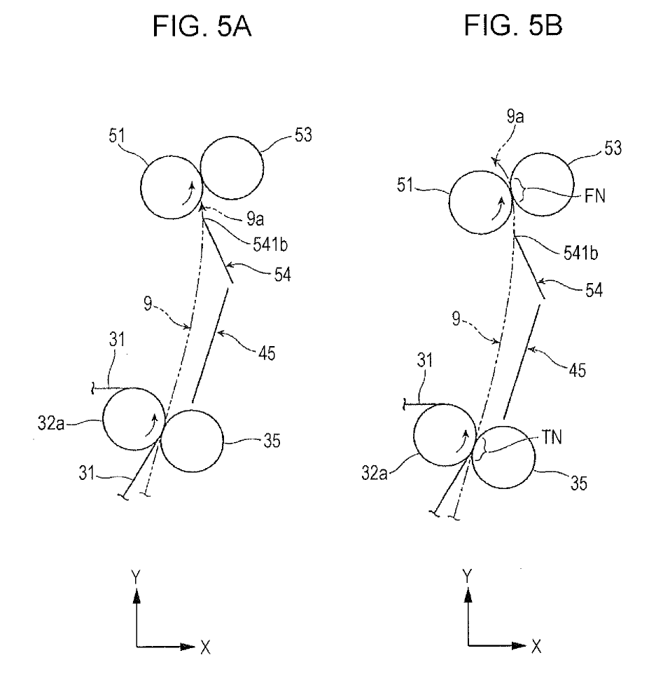

Referring next to FIG. 5A and 5B, the leading end 9a of the recording sheet 9 on the downstream side in the transport direction of the recording sheet 9 having been transported to the entrance 50a of the fixing device 5 is brought into contact with the guide portion 541 of the introduction guide member 54 of the fixing device 5 so as to be guided to part of the outer circumferential surface of the heating roller 51 approaching the pressure contact portion FN (FIG. 5A). After that, the leading end 9a of the recording sheet 9 is introduced into and passes through the pressure contact portion FN formed between the heating roller 51 and the pressure roller 53 which are being rotated (FIG. 5B) in the fixing device 5.

In so doing, the recording sheet 9 is heated and pressed in the pressure contact portion FN as described above, thereby the toner images are fixed.

Furthermore, at the start of the introduction of the leading end 9a of the recording sheet 9 into the pressure contact portion FN of the fixing device 5, part of the recording sheet 9 on the trailing end side not having reached the pressure contact portion FN is nipped in the pressure contact portion TN of the second transfer portion (FIG. 5B).

Furthermore, while the recording sheet 9 is being nipped in both the pressure contact portion FN of the fixing device 5 and the pressure contact portion TN of the second transfer portion, the part of the recording sheet 9 on the trailing end side not having reached the pressure contact portion FN of the fixing device 5 is affected by the transport speed in the pressure contact portion TN of the second transfer portion due to the above-described difference in rotational speed between the heating roller 51 and the support roller 32a, so that the part of the recording sheet 9 on the trailing end side not having reached the pressure contact portion FN of the fixing device 5 is transported (fed from the pressure contact portion TN of the second transfer portion) at a speed relatively higher than the speed at which part of the recording sheet 9 on the leading end 9a side nipped in the pressure contact portion FN of the fixing device 5 is transported. Thus, part of the recording sheet 9 nipped in both the pressure contact portion FN of the fixing device 5 and the pressure contact portion TN of the second transfer portion is in an unstable state in which this part of the recording sheet 9 tends to be slightly deformed.

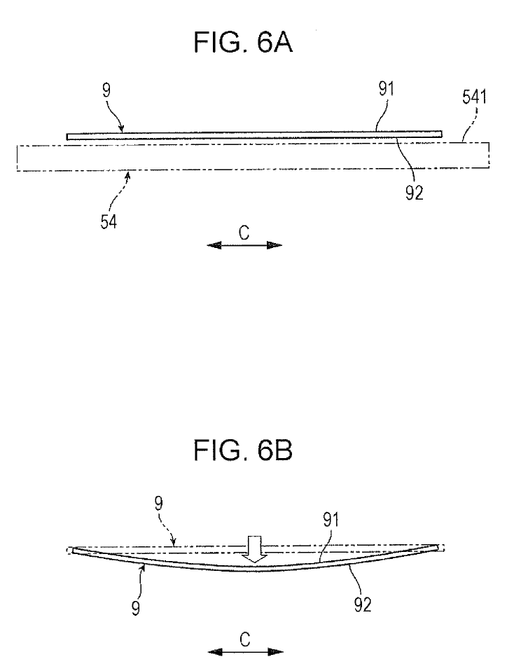

When the recording sheet 9 is transported while being in contact with the guide portion 541 of the introduction guide member 54 of the fixing device 5 (FIG. 5A), part of the recording sheet 9 in contact with the guide portion 541, the part of the recording sheet 9 extending in the rotational axis direction C of the heating roller 51, is maintained in a state in which this part of the recording sheet 9 substantially straightly extends so as to follow the flat shape of the guide portion 541 as exemplified in FIG. 6A. Reference numeral 91 of, for example, FIGS. 6A and 6B, denotes a transfer (printing) surface of the recording sheet 9 onto which the toner images to be fixed have been transferred, and reference numeral 92 denotes a non-transfer side of the recording sheet 9.

Furthermore, when the recording sheet 9 is introduced into and passes through the pressure contact portion FN of the fixing device 5 (FIG. 5B), since the shape of the pressure contact portion FN in the rotational axis direction C is a curved shape in which a central portion projects due to the above-described shape of the outer circumferential surface of the heating roller 51 (FIG. 3), a central portion 9c of the recording sheet 9 in the rotational axis direction C is maintained in a state in which, as exemplified in FIG. 6B, the central portion 9c of the recording sheet 9 is deformed so as to be recessed in a central portion of this part of the transfer side 91 in the rotational axis direction C.

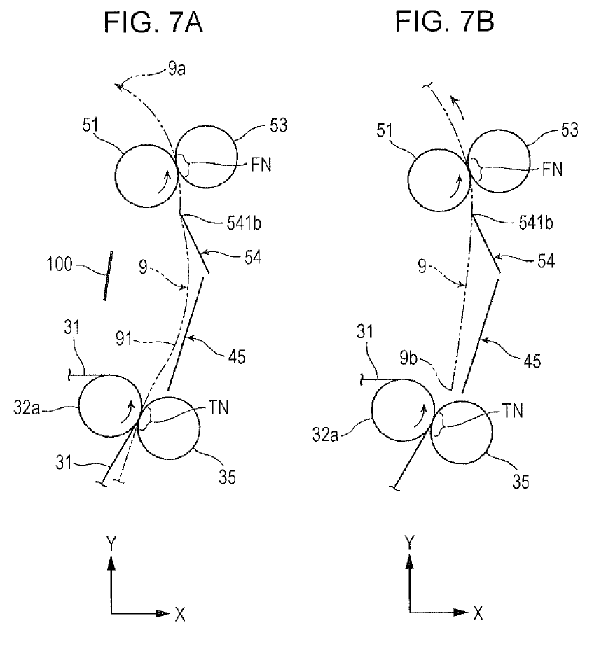

Thus, in the fixing device 5, the part of the recording sheet 9 on the trailing end side not having reached the pressure contact portion FN is, as described above, fed from the pressure contact portion TN of the second transfer portion and transported toward the fixing device 5 at a relatively high speed. However, at this time, as illustrated in FIG. 7A, part of the recording sheet 9 introduced into and passing through the pressure contact portion FN of the fixing device 5 is maintained in, as described above, the following shape: that is, this part of the recording sheet 9 is deformed so as to be recessed. Thus, the central portion 9c of the part of the recording sheet 9 (non-transfer side 92) on the trailing end side not having reached the pressure contact portion FN is transported in a state in which the central portion 9c of the part of the recording sheet 9 is deformed so as to be curved toward the post-transfer guide member 45 and the introduction guide member 54 in the transport direction.

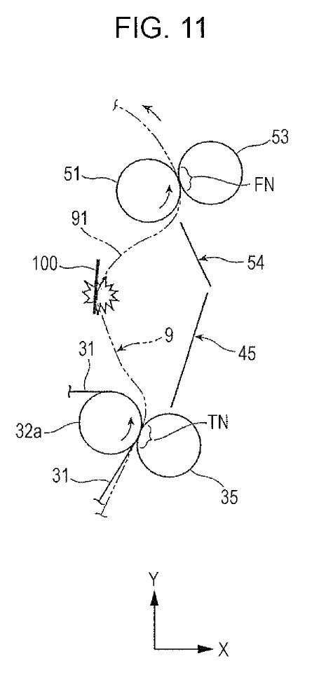

As a result, the occurrences of the following situation may be avoided with the fixing device 5: that is, the part of the recording sheet 9 (transfer side 91) on the trailing end side not having reached the pressure contact portion FN is brought into contact with (slides against) the outer circumferential surface of the heating roller 51 or peripheral components 100 (for example, a support member of the image forming apparatus 1 and an edge portion of the entrance 50a of the housing 50 of the fixing device 5) disposed upstream of the heating roller 51 in the transport direction of the recording sheet 9 (see FIG. 11).

Accordingly, this fixing device 5 may suppress image disturbances (so-called smudging) caused by the contact of part of the transfer side 91 of the recording sheet 9 with the peripheral components 100 disposed upstream of the heating roller 51 in the transport direction of the recording sheet 9, the outer circumferential surface of the heating roller 51, or the like after part of the recording sheet 9 on the leading end 9a side of the recording sheet 9 onto which the toner images have been transferred has been introduced into the pressure contact portion FN.

In the fixing device 5, when a trailing end 9b of the recording sheet 9 is finally fed from the pressure contact portion TN of the second transfer portion, as exemplified in FIG. 7B, the state in which the part of the recording sheet 9 on the trailing end side not having reached the pressure contact portion FN is deformed so as to be curved toward the post-transfer guide member 45 and the introduction guide member 54 in the transport direction is released and eliminated. specifically, even at this time, the part of the recording sheet 9 on the trailing end side not having reached the pressure contact portion FN passes through and is transported while being in contact with or approaching the guide ending portion 541b of the guide portion 541 of the introduction guide member 54.

Thus, the fixing device 5 may suppress the occurrences of the smudging, and accordingly, the image forming apparatus 1 using the above-described fixing device 5 may form images in which the image disturbances caused by the smudging in the fixing device 5 are suppressed.

When a heating roller 510 having an outer diameter R that is uniform from one end to the other end in the rotational axis direction C or that gradually increases from the center toward both the ends in the rotational axis direction C is applied to the fixing device 5 instead of the heating roller 51, the smudging may occur as described below.

That is, in the fixing device 5 to which the above-described heating roller 510 is applied, initially, the shape of the pressure contact portion FN in the rotational axis direction C corresponds to the shape of the outer circumferential surface of the heating roller 510. Thus, the shape of the pressure contact portion FN in the rotational axis direction C is straight throughout the length thereof or curved such that both the ends thereof project toward the pressure roller 53 side.

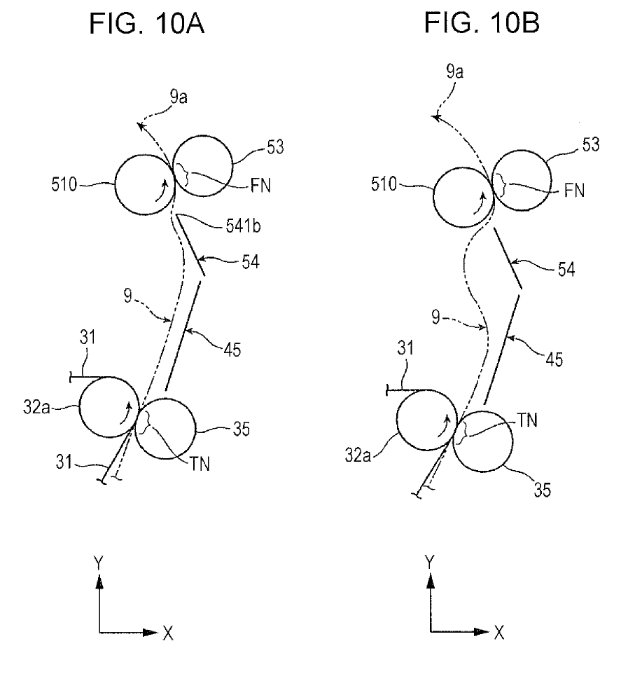

With this fixing device 5, as exemplified in FIG. 10A, when the recording sheet 9 onto which the toner images have been transferred is started to be introduced into the pressure contact portion FN formed between the heating roller 510 and the pressure roller 53, part of the recording sheet 9 having been introduced into the pressure contact portion FN is maintained in the shape corresponding to the above-described shape of the pressure contact portion FN in the rotational axis direction C. At this time, part of the recording sheet 9 on the trailing end side not having reached the pressure contact portion FN is transported at a relatively high speed by the pressure contact portion TN of the second transfer portion. Accordingly, the recording sheet 9 in this state is started to be curved so as to approach the outer circumferential surface of the heating roller 510 in a region between the pressure contact portion FN and the guide ending portion 541b of the guide portion 541 of the introduction guide member 54.

After that, as illustrated in FIG. 10B, the part of the recording sheet 9 on the trailing end side not having reached the pressure contact portion FN is transported in a state in which this part of the recording sheet 9 is, triggered by the start of the change into this curved state, deformed so as to be curved away from the introduction guide member 54 and the post-transfer guide member 45 in the transport direction. As a result, as exemplified in FIG. 11, the part of the recording sheet 9 (transfer side 91) having been deformed so as to be curved is partially brought into contact with the peripheral components 100 disposed upstream of the heating roller 510 in the transport direction of the recording sheet 9 or the outer circumferential surface of the heating roller 510. This may lead to the occurrences of the smudging.

Such smudging may tend to occur particularly when a sheet of paper having a comparatively low stiffness and a comparatively large length in the transport direction (for example, a thin sheet of paper having a large length during transport) is used as the recording sheet 9. The reason for this is that, with a sheet of paper having a comparatively low stiffness and a comparatively large length, part of the sheet on the trailing end side not having reached the pressure contact portion FN is easily deformed so as to be curved as described above. Furthermore, with such a sheet, the degree of the deformation into a curve tends to increase.

Furthermore, such smudging may also tend to occur particularly when a heating roller having an outer diameter R that gradually increases from the center toward both ends in the rotational axis direction C is applied as the heating roller 510. The reason for this is as follows: the pressure contact portion FN formed by such a heating roller 510 has a curved shape in the rotational axis direction C in which both the ends thereof project due to the shape of the outer circumferential surface of the heating roller 510; this causes part of the recording sheet 9 extending in the rotational axis direction C introduced into and passing through this pressure contact portion FN to be maintained in a curved state in which the central portion is disposed closer the heating roller 510 side than both the ends in the rotational axis direction C; accordingly, the recording sheet 9 tends to be transported in a state in which the recording sheet 9 is deformed so as to be curved away from the introduction guide member 54 and the post-transfer guide member 45 in the transport direction of the recording sheet 9, that is, curved toward the peripheral components 100 disposed upstream of the heating roller 510 in the transport direction of the recording sheet 9 or the outer circumferential surface of the heating roller 510.

### Variants

According to the exemplary embodiment, the shape of the outer circumferential surface of the heating roller 51 is such that the outer diameter R gradually reduces from the center P1 toward both the ends P2 and P3 in the rotational axis direction C. This shape is formed by processing the surface layer 513 so that the above-described outer diameter R is provided. However, a method of producing the heating roller 51 having the above-described outer diameter R is not limited to this.

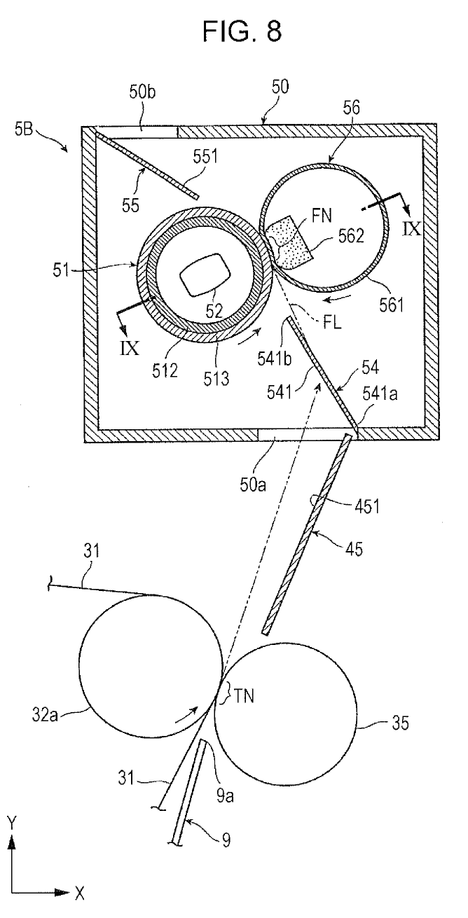

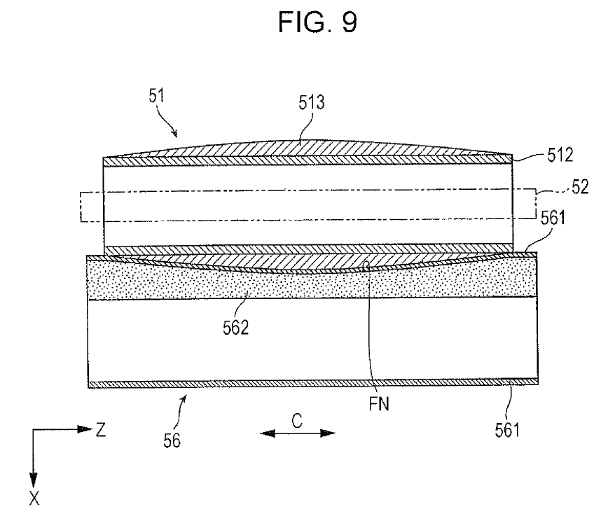

Furthermore, according to the exemplary embodiment, the pressure roller 53 in the form of a roller is applied as the pressure rotary member that is rotated while forming the pressure contact portion FN through pressure contact with the part of the outer circumferential surface of the heating roller 51 extending in the rotational axis direction C. However, another structure may be applied to the pressure rotary member. Specifically, as exemplified in FIGS. 8 and 9, a pressure rotary member 56 in the form of a belt may be applied.

The pressure rotary member 56 in the form of a belt includes the following components: an endless rotating belt 561, a pressure member 562, a support member (not illustrated), a support structure (not illustrated), and so forth. The rotating belt 561 is able to be rotated through contact thereof with part of the outer circumferential surface of the heating roller 51 extending in the rotational axis direction C. The pressure member 562 forms the pressure contact portion FN by pressing the rotating belt 561 against the outer circumferential surface of the heating roller 51 from an inner circumferential side of the rotating belt 561. The rotating belt 561 is rotatably supported by the support member. The support structure supports the pressure member 562 in a pressed state. Furthermore, the pressure member 562 of the pressure rotary member 56 in the form of a belt is entirely or partly formed of an elastic material that is elastically deformed so as to follow the shape of the outer circumferential surface of the heating roller 51 when the pressure member 562 is in pressure contact with the heating roller 51 with the rotating belt 561 interposed therebetween.

In this fixing device 5B to which the pressure rotary member 56 in the form of a belt is applied, the shape of the outer circumferential surface of the heating roller 51 is formed such that the outer diameter R of the heating roller 51 gradually reduces from the center P1 toward both the ends P2 and P3 in the rotational axis direction C, and the pressure member 562 of the pressure rotary member 56 is elastically deformed so as to follow the shape of the outer circumferential surface of the heating roller 51. This causes the pressure contact portion FN to have a curved shape in the rotational axis direction C in which a central portion projects toward the pressure member 562 of the pressure rotary member 56 side as exemplified in FIG. 9.

Furthermore, although a member having a flat surface (flat plate or the like) as the guide portion 541 is applied to the introduction guide member 54 according to the exemplary embodiment, this is not particularly limiting. Examples of another introduction guide member 54 include, for example, a plate-shaped base member having a portion including straight ridge forms (ribs) that extend in the transport direction of the recording sheet 9 and are arranged parallel to one another on a surface serving as the guide portion 541. Alternatively, the introduction guide member 54 may include plural plates that extend in the transport direction of the recording sheet 9 and are arranged parallel to one another. In this case, long side portions of the plates extending in the transport direction are collectively used as a single guide portion.

Furthermore, the fixing device 5 is disposed such that the pressure contact portion FN thereof is disposed at a position separated from the pressure contact portion TN of the second transfer portion above the pressure contact portion TN in the gravity direction according to the exemplary embodiment. However, this is not limiting. The fixing device 5 may be disposed, for example, such that the pressure contact portion FN thereof is disposed at a position separated from the pressure contact portion TN of the second transfer portion in the substantially horizontal direction.

Furthermore, the image forming apparatus to which the exemplary embodiment of the present invention is applied may adopt a so-called side registration method as the transport regulating method. The side registration method regulates the transport of the recording sheet 9 as follows: that is, the recording sheet 9 is transported so that one of end edges in the feed width of the recording sheet 9 passes through a position at one of the end portions of the feed width of the recording-sheet-9 transport path. In this case, the fixing device 5 may have a structure with which the recording sheet 9 transported with the side registration method is introduced into the pressure contact portion FN without a change in the state of the recording sheet 9. Alternatively, the fixing device 5 may have a structure (arrangement) with which the central portion of the recording sheet 9 transported with the side registration method, the central portion located at the center in the feed width, passes through a substantially central position of the pressure contact portion FN in the rotational axis direction C.

Furthermore, the image forming apparatus to which the exemplary embodiment of the present invention is applied is not limited to the image forming apparatus 1 exemplified in the exemplary embodiment. The image forming apparatus may include, for example, the image forming section 2 that directly transfers toner images from image holding members such as photosensitive drums (onto the recording sheet 9 without using the intermediate transfer device 30) or include the image forming section 2 that forms a monochrome image and transfers the monochrome image onto a recording sheet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heater;
a heating roller that has an outer circumferential surface, that has a center and one and another ends in a rotational axis direction thereof, and that is rotated while being heated by the heater;
a pressure rotary member that is in pressure contact with part of the outer circumferential surface of the heating roller extending in an axial direction of the heating roller so as to be rotated while forming a pressure contact portion which allows a recording medium having a leading end and bearing an unfixed image having been transferred to the recording medium to be introduced thereinto and pass therethrough; and
a guide member that guides the leading end of the recording medium toward part of the outer circumferential surface of the heating roller approaching the pressure contact portion,
wherein the heating roller has a shape in which an outer diameter thereof gradually reduces from the center toward the one and the other ends.

2. The fixing device according to claim 1,
wherein the pressure rotary member includes an elastic layer that is elastically deformed when the pressure rotary member is in pressure contact with the heating roller.

3. An image forming apparatus comprising:
an image forming section that forms an unfixed image formed of developer and that transfers the unfixed image to a recording medium; and
a fixing device that fixes the unfixed image having been transferred to the recording medium by the image forming section,
wherein the fixing device is according to claim 1.
